(19) United States
(12) Patent Application Publication
(10) Pub. No.: US 2022/0166006 A1
(43) Pub. Date: May 26, 2022

(54) NEGATIVE ELECTRODE FOR LITHIUM-ION SECONDARY BATTERY

(71) Applicant: HONDA MOTOR CO., LTD., Tokyo (JP)

(72) Inventor: Kazuki SAIMEN, Saitama (JP)

(21) Appl. No.: 17/456,159

(22) Filed: Nov. 22, 2021

(30) Foreign Application Priority Data
Nov. 26, 2020 (JP) 2020-195665

(51) Int. Cl. H01M 4/36; H01M 4/587; H01M 10/0525

(52) U.S. Cl. CPC H01M 4/364; H01M 2004/021; H01M 10/0525; H01M 4/587

(57) ABSTRACT

The present disclosure is intended to provide a negative electrode for a lithium-ion secondary battery, the negative electrode being capable of reducing an increase in internal resistance even when charge-discharge cycles are repeated, and enabling production of a lithium-ion secondary battery with excellent durability against the charge-discharge cycles. A negative electrode for a lithium-ion secondary battery includes: an electrode material mixture layer including graphite particles as a negative electrode active material, and a high dielectric inorganic solid. The graphite particles include graphite particles A having an average particle diameter and graphite particles B having a different average particle diameter. The graphite particles each include, on a surface thereof, a portion in contact with the high dielectric inorganic solid and a portion in contact with an electrolytic solution.

This application is based on and claims the benefit of priority from Japanese Patent Application No. 2020-195665, filed on 26 Nov. 2020, the content of which is incorporated herein by reference.

### BACKGROUND OF THE INVENTION

### Field of the Invention

The present disclosure relates to a negative electrode for a lithium-ion secondary battery.

### Related Art

Various lithium-ion secondary batteries including lithium-ion conductive solid electrolytes have been proposed. For example, a known lithium-ion secondary battery includes, in its positive or negative electrode, an active material coated with a coating layer containing a conductive aid and a lithium-ion conductive solid electrolyte (see, for example, Patent Document 1).

According to the lithium-ion secondary battery disclosed in Patent Document 1, since the positive or negative electrode includes the active material coated with the coating layer containing the conductive aid and the lithium-ion conductive solid electrolyte, internal resistance can be reduced to a low value and the active material is inhibited from deforming during charge and discharge. Consequently, deterioration of charge-discharge cycle characteristics and high-rate discharge characteristics can be prevented.

Patent Document 1: Japanese Unexamined Patent Application, Publication No. 2003-59492

### SUMMARY OF THE INVENTION

Although the lithium-ion secondary battery of Patent Document 1 satisfactorily exerts the above-mentioned effects in an initial stage of the charge-discharge cycles, the lithium-ion secondary battery has a disadvantage that its durability against charge and discharge rapidly decreases during use. The present disclosure has been achieved in view of the foregoing, and is intended to provide a negative electrode for a lithium-ion secondary battery, the negative electrode being capable of reducing an increase in internal resistance even when charge-discharge cycles are repeated, and enabling production of a lithium-ion secondary battery with excellent durability against the charge-discharge cycles.

A first aspect of the present disclosure is directed to a negative electrode for a lithium-ion secondary battery. The negative electrode includes: an electrode material mixture layer including graphite particles as a negative electrode active material, and a high dielectric inorganic solid. The graphite particles include graphite particles A having an average particle diameter and graphite particles B having a different average particle diameter. The graphite particles each include, on a surface thereof, a portion in contact with the high dielectric inorganic solid and a portion in contact with an electrolytic solution.

The first aspect of the present disclosure provides the negative electrode for a lithium-ion secondary battery, the negative electrode being capable of reducing an increase in internal resistance even when charge-discharge cycles are repeated, and enabling production of a lithium-ion secondary battery having excellent durability against the charge-discharge cycles.

A second aspect of the present disclosure is an embodiment of the first aspect. In the negative electrode of the second aspect, the high dielectric inorganic solid is disposed in gaps between the graphite particles or on the surfaces of the graphite particles.

According to the second aspect, a lithium-ion secondary battery having excellent durability against charge-discharge cycles can be achieved.

A third aspect of the present disclosure is an embodiment of the first or second aspect. In the negative electrode of the third aspect, the graphite particles A are integrated with the high dielectric inorganic solid and have a BET specific surface area of 1 m²/g to 3 m²/g, and the average particle diameter of the graphite particles A is 15 μm to 30 μm. The graphite particles B have a BET specific surface area of 3 m2/g to 3 m²/g, and the average particle diameter of the graphite particles B is 5 μm to 15 μm.

The negative electrode of the third aspect has good packing properties and makes it possible to produce a lithium-ion secondary battery having excellent durability against charge-discharge cycles.

A fourth aspect of the present disclosure is an embodiment of any one of the first to third aspects. In the negative electrode of the fourth aspect, the high dielectric inorganic solid includes at least one of Li, Na, or Mg.

According to the fourth aspect, a free solvent in the electrolytic solution is captured so that a pseudo-solvation state is brought about. The pseudo-solvation state stabilizes the solvent, whereby decomposition of the electrolytic solution can be suppressed, and the capacity of a secondary battery can be inhibited from decreasing.

A fifth aspect of the present disclosure is an embodiment of any one of the first to fourth aspects. In the negative electrode of the fifth aspect, the high dielectric inorganic solid has a reductive decomposition potential of 1.5 V (vs. Li/Li⁺) or less with respect to a Li/Li⁺ equilibrium potential.

According to the fifth aspect, a lithium-ion secondary battery having excellent durability against charge-discharge cycles can be achieved.

A sixth aspect of the present disclosure is an embodiment of any one of the first to fifth aspects. In the negative electrode of the sixth aspect, the high dielectric inorganic solid has a relative permittivity of 10 or higher.

According to the sixth aspect, the high dielectric inorganic solid is polarized, thereby making it possible to capture, on the surfaces of the graphite particles, fluorine-based anions and acids generated due to decomposition of a solvent. As a result, corrosion of a positive electrode active material can be suppressed, thereby enabling suppression of a crack in the positive electrode active material and dissolution of metals that can be caused by charge and discharge. This feature makes it possible to reduce an increase in resistance of a secondary battery that can be caused by charge-discharge cycles.

A seventh aspect of the present disclosure is an embodiment of any one of the first to sixth aspects. In the negative electrode of the seventh aspect, the graphite particles A are contained at 55 wt. % to 95% wt. % with respect to a total weight of the graphite particles A and the graphite particles B.

According to the seventh aspect, a lithium-ion secondary battery having excellent durability against charge-discharge cycles can be achieved.

An eighth aspect of the present disclosure is an embodiment of any one of the first to seventh aspects. In the negative electrode of the eighth aspect, the high dielectric inorganic solid includes at least one of compounds represented by Na₃₊ₓ(Sb₁₋ₓ, Snₓ)S₄ (0≤X≤0.1).

According to the eighth aspect, a lithium-ion secondary battery having excellent durability against charge-discharge cycles can be achieved.

A ninth aspect of the present disclosure is an embodiment of any one of the first to eighth aspects. In the negative electrode of the ninth aspect, the high dielectric inorganic solid is contained at 0.1 wt. % to 1.0 wt. % in the electrode material mixture layer.

According to the ninth aspect, a lithium-ion secondary battery having excellent durability against charge-discharge cycles can be achieved.

### BRIEF DESCRIPTION OF THE DRAWINGS

FIG. 1 is a diagram illustrating a cross section of a lithium-ion secondary battery according to an embodiment; and

FIG. 2 is a schematic diagram illustrating an active material for use in the lithium-ion secondary battery according to the embodiment.

### DETAILED DESCRIPTION OF THE INVENTION

An embodiment of the present disclosure will be described below with reference to the drawings. Note that the following embodiment is not intended to limit the scope of the present disclosure.

### Lithium-Ion Secondary Battery

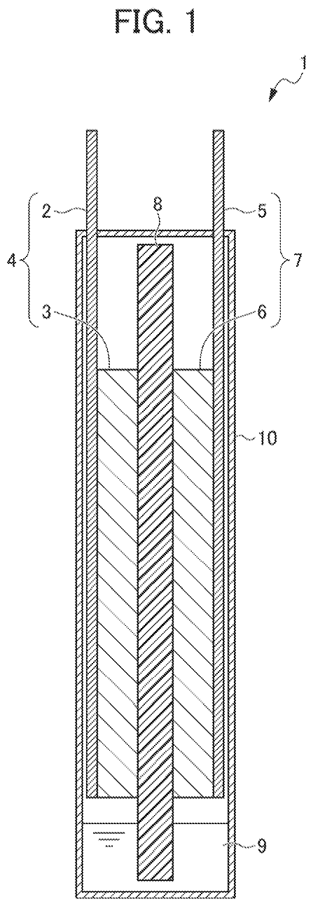

Graphite particles according to the present embodiment are for use as, for example, a negative electrode active material for a lithium-ion secondary battery. As illustrated in FIG. 1, the lithium-ion secondary battery 1 according to the present embodiment includes: a positive electrode 4 including a positive electrode current collector 2 having a positive electrode material mixture layer 3 formed thereon; a negative electrode 7 including a negative electrode current collector 5 having a negative electrode material mixture layer 6 formed thereon; a separator 8 electrically insulating the positive electrode 4 from the negative electrode 7; an electrolytic solution 9; and a container 10.

### Current Collectors

Examples of materials for each of the positive electrode current collector 2 and the negative electrode current collector 5 include, but are not limited to, a copper foil or plate, an aluminum foil or plate, a nickel foil or plate, a titanium foil or plate, a stainless-steel foil or plate, a carbon sheet, and a carbon nanotube sheet. One of these materials may be used alone. Alternatively, a metal clad foil composed of two or more of these materials may be used, as needed. Each of the positive electrode current collector 2 and the negative electrode current collector 5 can have any thickness, and may be 5 μm to 100 μm in thickness, for example. From the viewpoint of structure and performance improvement, it is preferable that the thickness of each of the positive electrode current collector 2 and the negative electrode current collector 5 is within the range from 7 μm to 20 μm.

### Electrode Material Mixture Layers

The positive electrode material mixture layer 3 includes a positive electrode active material, a conductive aid, and a binding agent (binder). The negative electrode material mixture layer 6 includes a negative electrode active material, a conductive aid, and a binding agent (binder).

### Active Materials

Examples of the positive electrode active material include, but are not limited to, lithium composite oxides (LiNiₓCo_{y}Mn_{z}O₂ (x+y+z=1), LiNiₓCo_{y}Al_{z}O₂ (x+y+z=1)) and lithium iron phosphate (LiFePO₄ (LFP)). One of these compounds may be used alone. Alternatively, two or more of these compounds may be used in combination.

Graphite particles are used as the negative electrode active material. Examples of the graphite particles include, but are not limited to, (highly graphitizable carbon), hard carbon (non-graphitizable carbon), and graphite (black lead). One of these materials may be used alone. Alternatively, two or more of these materials may be used in combination. Details of the negative electrode active material will be described later.

### Conductive Aid

Examples of the conductive aid as a constituent of each of the positive electrode material mixture layer 3 and the negative electrode material mixture layer 6 include, but are not limited to: carbon black such as acetylene black (AB) and ketjen black (KB); carbon materials such as a graphite powder; and conductive metal powders such as a nickel powder. One of these materials may be used alone. Alternatively, two or more of these materials may be used in combination.

### Binding Agent

Examples of the binding agent as a constituent of each of the positive electrode material mixture layer 3 and the negative electrode material mixture layer 6 include, but are not limited to, cellulosic polymers, fluorinated resins, vinyl acetate copolymers, and rubbers. Specifically, in a case of using a solvent-based dispersion medium, examples of the binding agent include, but are riot limited to, polyvinylidene fluoride (PVdF), polyimide (PI), polyvinylidene chloride (PVdC), and polyethylene oxide (PEO). In a case of using an aqueous dispersion medium, examples of the binding agent include, but are not limited to, styrene-butadiene rubber (SBR), acrylic acid modified SBR resin (SBR-based latex), carboxymethyl cellulose (CMC), polyvinyl alcohol (PVA), polytetrafluoroethylene (PTFE), hydroxypropyl methyl cellulose (HPMC), and tetrafluoroethylene-hexafluoropropylene copolymer (FEP). One of these materials may be used alone. Alternatively, two or more of these materials may be used in combination.

### Separator

The separator 8 may include any material, and examples thereof include, but are not limited to, a porous resin sheet (e.g., a film or a non-woven fabric) made of a resin such as polyethylene (PE), polypropylene (PP), polyester, cellulose, or polyamide.

### Electrolytic Solution

The electrolytic solution 9 may include a non-aqueous solvent and an electrolyte. The electrolyte is preferably at a concentration within the range from 0.1 mol/L to 10 mol/L.

### Non-Aqueous Solvent

The non-aqueous solvent included in the electrolytic solution 9 is not limited to any particular solvent, and examples thereof include, but are not limited to, aprotic solvents such as carbonates, esters, ethers, nitriles, sulfones, and lactones. Specifically, the examples include, but are not limited to, ethylene carbonate (EC), propylene carbonate (PC), diethyl carbonate (DEC), dimethyl carbonate (DMC), ethyl methyl carbonate (EMC), 1,2-dimethoxyethane (DME), 1,2-diethoxyethane (DEE), tetrahydrofuran (THF), 2-methyltetrahydrofuran, dioxane, 1,3-dioxolane, diethylene glycol dimethyl ether, ethylene glycol dimethyl ether, acetonitrile (AN), propionitrile, nitromethane, N,N-dimethylformamide (DMF), dimethyl sulfoxide, sulfolane, and γ-butyrolactone.

### Electrolyte

Examples of the electrolyte included in the electrolytic solution 9 include, but are not limited to, LiPF₆, LiBF₄, LiClO₄, LiN(SO₂CF₃), LiN(SO₂C₂F₅)₂, LiCF₃SO₃, LiC₄F₉SO₃, LiC(SO₂CF₃)₃, LiF, LiCl, LiI, Li₂S, Li₃N, Li₃P, Li₁₀GeP₂S₁₂ (LGPS), Li₃PS₄, Li₆PS₅Cl, Li₇P₂S₈I, LiₓPO_{y}N_{z} (x=2y+3z−5, LiPON), Li₇La₃Zr₂O₁₂ (LLZO), Li₃ₓLa_{2/3-x}TiO₃ (LLTO), Li₁₊ₓAlₓTi₂₋ₓ(PO₄)₃ (0≤x≤1, LATP), Li_{1.5}Al_{0.5}Ge_{1.5}(PO₄)₃ (LAGP), Li_{1+x+y}AlₓTi₂₋ₓSi_{y}P_{3-y}O₁₂, Li_{1+x+y}Alₓ(Ti,Ge)₂₋ₓSi_{y}P_{3-y}O₁₂, and Li₄₋₂ₓZnₓGeO₄ (LISICON). Among these, LiPF₆, LiBF₄, or a mixture thereof is preferably used as the electrolyte.

In addition to the above, the electrolytic solution 9 may include an ionic liquid or an ionic liquid and a polymer containing an aliphatic chain, such as polyethylene oxide (PEO) or a polyvinylidene fluoride (PVdF) copolymer. Inclusion of, for example, the ionic liquid allows the electrolytic solution 9 to flexibly cover the surface of the positive electrode active material and the surface of the negative electrode active material, thereby making it possible to satisfactorily form contact sites between the electrolytic solution 9 and the positive electrode active material and the negative electrode active material.

A part of the electrolytic solution 9 fills voids of the positive electrode material mixture layer 3, voids of the negative electrode material mixture layer 6, and the pores of the separator 8. Another part of the electrolytic solution 9 is stored in a bottom portion of the container 10. The electrolytic solution 9 can be distributed such that the mass of the part stored in the bottom portion of the container 10 is within the range of 3 mass % to 25 mass % with respect to the mass of the part filling the voids of the positive electrode material mixture layer 3, the voids of the negative electrode material mixture layer 6, and the pores of the separator 8. The mass of the part of the electrolytic solution 9 filling the voids of the positive electrode material mixture layer 3, the voids of the negative electrode material mixture layer 6, and the pores of the separator 8 can be calculated from, for example, a specific gravity of the electrolytic solution 9 and a total volume of the voids of the positive electrode material mixture layer 3, the voids of the negative electrode material mixture layer 6, and the pores of the separator 8 as measured with a mercury porosimeter. Alternatively, the total volume of the voids of the positive electrode material mixture layer 3, the voids of the negative electrode material mixture layer 6, and the pores of the separator 8 may be calculated from densities of the positive electrode material mixture layer 3 and the negative electrode material mixture layer 6, densities of the materials constituting the material mixture layers, and a porosity of the separator 8.

When the electrolytic solution 9 is consumed, the configuration in which the electrolytic solution 9 stored in the container 10 is in contact with the separator 8 allows the electrolytic solution 9 to be replenished to the positive electrode material mixture layer 3 and the negative electrode material mixture layer 6 via the separator 8.

The container 10 contains the positive electrode 4, the negative electrode 7, the separator 8, and the electrolytic solution 9. In the container 10, the positive electrode material mixture layer 3 and the negative electrode material mixture layer 6 face each other while having the separator 8 interposed there between, and the electrolytic solution 9 is stored below the positive electrode material mixture layer 3 and the negative electrode material mixture layer 6. The separator 8 has an end immersed in the electrolytic solution 9. The container 10 may have any configuration. Any known container for use for secondary batteries can be employed as the container 10.

### Negative Electrode Active Material (Graphite Particles)

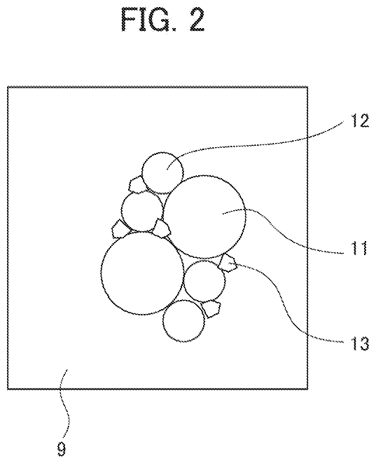

As illustrated in FIG. 2, the graphite particles as the negative electrode active material include graphite particles A (11) having an average particle diameter and graphite particles B (12) having a different average particle diameter. Combining the graphite particles having different average particle diameters can improve packing properties of the graphite particles. As a result, a discharge capacity of a lithium-ion secondary battery can be increased.

The graphite particles A (11) have a structure in which a high dielectric inorganic solid 13 is internally integrated with the graphite particles A (11). Preferably, the graphite particles A (11) have a BET specific surface area of 1 m²/g to 3 m²/g, and the average particle diameter is 15 μm to 30 μm. Preferably, the graphite particles B (12) have a BET specific surface area of 3 m²/g to 8 m²/g, and the average particle diameter is 5 μm to 15 μm. The average particle diameter refers to a median diameter (D50).

The graphite particles A (11) are preferably contained at 55 wt. % to 95 wt. % with respect to the total weight of the graphite particles A (11) and the graphite particles B (12). More preferably, the graphite particles A are contained at 55 wt % to 70 wt. %.

Since it is difficult for the electrolytic solution 9 to permeate the negative electrode 7 in which the negative electrode active material is densely packed, the negative electrode active material may be non-uniformly impregnated with the electrolytic solution 9. On the surface of the negative electrode active material impregnated with a small amount of the electrolytic solution 9, release and implantation of lithium ions take place with high internal resistance. If charge and discharge are repeated in this state, variation in the electric potential increases in the negative electrode active material. This situation may cause the solvent of the electrolytic solution 9 to decompose on the surface of the negative electrode active material, thereby giving rise to the risk of exhaustion of the electrolytic solution 9. If finer particles are used as the negative electrode active material in order to improve the charge performance, the specific surface area of the particles increases, which makes it more likely for the solvent of the electrolytic solution 9 to decompose.

### High Dielectric Inorganic Solid

The high dielectric inorganic solid 13 is preferably disposed in gaps between the particles of the negative electrode active material or on the surfaces of the particles of the negative electrode active material. The high dielectric inorganic solid 13 reduces a surface potential of the negative electrode active material, the surface potential being caused by the electrolytic solution 9. Consequently, interfacial resistance for lithium ions between the negative electrode active material and the high dielectric inorganic solid 13 is reduced, thereby reducing transfer resistance for the lithium ions. This feature can reduce an increase in internal resistance that can be caused when charge-discharge cycles of the lithium-ion secondary battery 1 are repeated, and can suppress the decomposition of the solvent of the electrolytic solution 9 on the surface of the negative electrode active material. In addition, the suppression of decomposition of the solvent of the electrolytic solution 9 inhibits growth of a SEI coating formed on the surface of the negative electrode active material, so that the permeability of the electrolytic solution 9 into the graphite particles as the negative electrode active material is maintained and the precipitation of lithium on the surface of the negative electrode active material can be suppressed.

Many of voids in the graphite particles as the negative electrode active material have a diameter of less than 100 nm and have a long path through which the high dielectric Inorganic solid 13 is allowed to penetrate into them. In addition, the particles of the high dielectric inorganic solid 13 have a particle diameter of 100 nm or greater in many cases. For these reasons, there is a problem in that the particles of the high dielectric inorganic solid 13 concentrate between the graphite particles. The graphite particles A of the present embodiment have a structure in which the high dielectric inorganic solid 13 is internally integrated. This structure prevents the uneven distribution of the particles of the high dielectric inorganic solid 13 and exerts an effect of suppressing the above-described decomposition of the solvent over the entire negative electrode 7. The term “being internally integrated” as used herein refers to a state in which the high dielectric inorganic solid 13 is physically incorporated into the interiors of the graphite particles A.

The high dielectric inorganic solid 13 is highly dielectric. Solid particles produced by way of pulverization of a solid in a crystalline state have a lower permittivity than the original solid in the crystalline state. Therefore, the particles of the high dielectric inorganic solid 13 of the present embodiment are preferably produced by pulverization while a high dielectric state is maintained to a maximum extent.

It is preferable for the high dielectric inorganic solid 13 to have a powder relative permittivity of 10 or higher. Due to such a powder relative permittivity, the high dielectric inorganic, solid 13 is intensely polarized, thereby making it possible to capture, on the surfaces of the graphite particles, fluorine-based anions (e.g., PF₆⁻) and acids generated by the decomposition of the solvent. Acids generated in the lithium-ion secondary battery 1 corrode the positive electrode active material and may cause a crack in the positive electrode active material and dissolution of metals. Making the high dielectric inorganic solid 13 have a powder relative permittivity of 10 or higher enables suppression of a crack in the positive electrode active material and dissolution of metals, thereby reducing an increase in resistance of the lithium-ion secondary battery 1 that is caused by the charge-discharge cycles. It is more preferable that the powder relative permittivity of the high dielectric inorganic solid 13 is 20 or higher.

The powder relative permittivity of the high dielectric inorganic solid 13 can be calculated in the follow manner. The powder is introduced into a tablet molder for measurement having a mold diameter (R) of 38 mm, and then, is compressed using a hydraulic press machine so that compacts having a thickness (d) of 1 mm to 2 mm are formed. The compact molding conditions are set as follows: Relative density of powder (D_{powder})=weight density of compact/true specific gravity of dielectric×100=40% or higher. A capacitance Cₜₒₜₐₗ of the resultant molded body at 25° C. and 1 kHz is measured by an automatic balancing bridge method using an LCR meter, and then, a compact relative permittivity εₜₒₜₐₗ is calculated. To determine a relative permittivity ε_{powder} of an actual volume part from the calculated compact relative permittivity, a relative permittivity of vacuum ε₀ is defined as 8.854×10⁻¹² and a relative permittivity of air εₐᵢᵣ is defined as 1, and the “powder relative permittivity ε_{powder}” is calculated according to the following equations (1) to (3). Contact area A between compact and electrode=(R/2)²*π(1)

Cₜₒₜₐₗ=εₜₒₜₐₗ×ε₀×(A/d) (2)

εₜₒₜₐₗ=ε_{powder}×D_{powder}+εₐᵢᵣ×(1−D_{powder}) (3)

From the viewpoint of improving the electrode-volumetric packing density of the active material, the particle diameter of the high dielectric inorganic solid 13 is preferably ⅕ or less of the particle diameter of the negative electrode active material, and is more preferably within the range from 0.02 μm to 1 μm. If the particle diameter of the high dielectric inorganic solid 13 is less than 0.02 μm, the high dielectricity cannot be maintained, and the effect of suppressing an increase in resistance may not be achieved.

It is preferable for the high dielectric inorganic solid 13 to include at least one of Li, Na, or Mg. The inclusion of at least one of Li, Na, or Mg allows the high dielectric inorganic solid 13 to have at least one of Li-ion conductivity, Na-ion conductivity, or Mg-ion conductivity. As a result, the particles of the high dielectric inorganic solid are polarized, thereby making it possible to capture, on the surfaces of the graphite particles of the negative electrode, fluorine-based anions (e.g., PF₆⁻) and acids generated by decomposition of the solvent. Acids generated in a lithium-ion secondary battery corrode the positive electrode active material. Suppression of the corrosion by way of capture of the generated acids leads to suppression of a crack in the positive electrode active material and dissolution of metals that can be caused by charge and discharge, thereby reducing an increase in resistance of the lithium-ion secondary battery caused by the charge-discharge cycles. In view of this, the above ion conductivity is preferably 10⁻⁷ S/cm or higher.

Preferably, the high dielectric inorganic solid 13 is, for example, Na₃₊ₓ(Sb₁₋ₓ,Snₓ)S₄ (0≤X≤0.1) or Na₃₋ₓSb₁₋ₓWₓS₄ (0≤X≤1). Specifically, examples of the high dielectric inorganic solid 13 include, but are not limited to, Na₃SbS₄, Na₂WS₄, and Na_{2.86}Sb_{0.86}W_{0.12}S₄. More preferably, the high dielectric inorganic solid 13 is Na₃₊ₓ(Sb₁₋ₓ,Snₓ)S₄ (0≤X≤0.1).

Other examples of the high dielectric inorganic solid 13 Include, but are not limited to, composite metal oxides having a perovskite-type crystal structure, such as BaTiO₃, BaₓSr₁₋ₓTiO₃ (X=0.4 to 0.8), BaZrₓTi₁₋ₓO₃ (X=0.2 to 0.5), and KNbO₃; and composite metal oxides having a layered perovskite-type crystal structure containing bismuth, such as SrBi₂Ta₂O₉ and SrBi₂Nb₂O₉.

Other examples of the high dielectric inorganic solid 13 include, but are not limited to, composite oxides having an ilmenite structure represented by, for example, LiₓNb_{y}O₃ or LiₓTa_{y}O₃ (x/y=0.9 to 1.1), Li₃PO₄, LiₓPO_{y}N_{z} (x=2y+3z−5, LIPON), Li₇La₃Zr₂O₁₂ (LLZO), Li₃ₓLa_{2/3-x}TiO₃ (LLTO), Li₁₊ₓAlₓTi₂₋ₓ(PO₄)₃ (0≤x≤1, LATP), Li_{1.5}Al_{0.5}Ge_{1.5}(PO₄)₃ (LAGP), Li_{1+x+y}AlₓTi₂₋ₓSi_{y}P_{3-y}O₁₂, Li_{1+x+y}Alₓ(Ti,Ge)₂₋ₓSi_{y}P_{3-y}O₁₂, or Li₄₋₂ₓZnₓGeO₄ (LISICON).

The high dielectric inorganic solid 13 preferably has a reductive decomposition potential of 1.5 V (1.5 V vs. Li/Li⁺) or less with respect to a Li/Li+ equilibrium potential. If the reductive decomposition potential of the high dielectric inorganic solid 13 exceeds 1.5 V, the crystal structure may change due to, for example, reductive decomposition, and consequently, ion conduction paths may disappear or charge bias may not occur in some cases.

The high dielectric inorganic solid 13 is preferably at a weight percentage of 0.1 wt. % to 1.0 wt. % in the negative electrode material mixture layer 6. When the weight percentage of the high dielectric inorganic solid 13 is less than 0.1 wt. %, the added amount is too small to achieve sufficient effects. When the weight percentage of the high dielectric inorganic solid 13 exceeds 1.0 wt. %, the high dielectric inorganic solid 13 may impede electron conduction between the graphite particles and may cause an increase in internal resistance.

In the foregoing, the case where in the lithium-ion battery 1, the negative electrode active material of the negative electrode material mixture layer 6 includes the high dielectric inorganic solid 13 has been described. However, the high dielectric inorganic solid 13 may be included in the positive electrode active material of the positive electrode material mixture layer 3.

### Method of Producing Graphite Particles

The graphite particles for use as the negative electrode active material of the lithium-ion secondary battery 1 according to the present embodiment can be produced by any method. For example, a method of producing the graphite particles includes dispersing graphite particles in a solution containing the high dielectric inorganic solid 13 and a solvent, and removing the solvent.

Examples of the solvent in which the high dielectric inorganic solid 13 is dissolved include ion-exchange water. Any process may be employed to disperse the graphite particles in the solution containing the solvent and the high dielectric inorganic solid 13 dissolved therein. It is possible to disperse the graphite particles by mixing and stirring the solution and the graphite particles using, for example, a known mixer device.

The process for removing the solvent may include vaporizing the solvent by way of heating and/or decompression. The process may include addition of a poor solvent in which the high dielectric inorganic solid 13 has a low degree of solubility so that the high dielectric inorganic solid 13 is precipitated, and, subsequent removal of the solvent.

In the foregoing, a preferred embodiment of the present disclosure has been described. It should be noted that the embodiment described above is not intended to limit the features of the present disclosure, and that appropriate modifications can be made to the present disclosure.

### Examples

The present disclosure will be described in more detail with reference to examples. The features of the present disclosure are not limited to the description of the following examples.

### Negative Electrode Active Material (Graphite Particles)

The graphite particles shown in Table 1 below were used as negative electrode active materials.

TABLE 1

| | | Average Particle | BET Specific |
|---|---|---|---|
| Type | | Diameter (D50, μm) | Surface Area (m²/g) |
| Graphite | A1 | 17 | 1.5 |
| Particles | A2 | 22 | 1.0 |
| A | A3 | 17 | 3.0 |
| Graphite | B1 | 11 | 5.0 |
| Particles | B2 | 14 | 4.0 |
| B | B3 | 10 | 7.2 |
| | B4 | 8 | 4.1 |

### High Dielectric Inorganic Solid

Table 2 below shows compounds used as high dielectric inorganic solids. Na₃SbS₄ was synthesized by a process to be described below. An ion conductivity and a powder relative permittivity were measured for each compound, and the measurement results are shown in Table 2.

### Synthesis of Na₃SbS₄

Na₃SbS₄ (NSS) was synthesized by the following process. 70.4 g of Na₂S, 75 g of Sb₂S₃, and 21 g of S were dissolved in 2210 ml of ion-exchange water, and the resultant solution was stirred at 70° C. for five hours. The solution was then cooled to 25° C., and undissolved substances were removed. Thereafter, 1400 ml of acetone was added and the solution was stirred for five hours, and then, allowed to stand for 12 hours. Drying was carried out at 200° C. under a reduced pressure, whereby Na₃SbS₄ was produced. The produced sample was subjected to XRD measurement, by which it was confirmed that the sample was in a crystalline phase of Na₃SbS₄ (H₂O)₉.

TABLE 2

| High | | Average | | |
|---|---|---|---|---|
| Dielectric | | Particle | Ion | Powder |
| Inorganic | | Diamter | Conductivity | Relative |
| Solid | Abbreviation | (D50, μm) | (S/cm) | Permittivity |
| LiNbO₃ | LNO | 0.5 | 5.0 × 10⁻⁶ | 38 |
| Li₃PO₄ | LPO | 0.7 | 1.0 × 10⁻⁷ | 28 |
| SrBi₂Ta₂O₉ | SBT | 0.4 | — | 15 |
| Na₃SbS₄ | NSS | 0.3 | 1.0 × 10⁻³ | 44 |

### Example 1

### Preparation of Positive Electrode

Acetylene black (AB) as an electron conductive material and polyvinylidene fluoride (PVdF) as a binding agent (binder) were pre-mixed with N-methyl-2-pyrrolidone (NMP) as a dispersion solvent. The mixture was wet-mixed using a planetary centrifugal mixer, thereby preparing a pre-mixed slurry. Subsequently, Li₁Ni_{0.6}Co_{0.2}Mn_{0.2}O₂ (NCM622) as a positive electrode active material was mixed with the pre-mixed slurry, and a dispersion process was carried out using a planetary mixer, thereby obtaining a positive electrode paste. The positive electrode paste was adjusted to have the following mass ratio between its constituents: NCM622:AB:PVdF=94.0:4.2:1.8. NCM622 had a median diameter of 12 μm. Next, the obtained positive electrode paste was applied to a positive electrode current collector made of aluminum, and dried. The current collector with the positive electrode paste applied thereto was pressurized with a roll press, and then, dried in a vacuum at 120° C., so that a positive electrode plate having a positive electrode material mixture layer was formed. The positive electrode plate was punched into a piece in a size of 30 mm×40 mm, which was used as the positive electrode.

### Preparation of Negative Electrode

An aqueous solution of carboxymethyl cellulose (CMC) as a binding agent (binder) and acetylene black (AB) as an electron conductive material were pre-mixed using a planetary mixer. Subsequently, graphite particles A1 (GA1) and graphite particles B1 (GB1) as a negative electrode active material and NSS as a high dielectric inorganic solid were added in the proportion shown in Table 3, and the resultant mixture was further pre-mixed using the planetary mixer. Thereafter, water as a dispersion solvent and styrene-butadiene rubber (SBR) as a binding agent (binder) were added, and a dispersion process was carried out using the planetary mixer, thereby obtaining a negative electrode paste. The negative electrode paste was adjusted to have the following mass ratio between its constituents: GA1:GB1:NSS:AB:CMC:SBR=90.7:4.8:1.0:1.0:1.0:1.5. Next, the obtained negative electrode paste was applied to a negative electrode current collector made of copper, and dried. The current collector with the negative electrode paste applied thereto was pressurized with a roll press, and then, dried in a vacuum at 130° C., so that a negative electrode plate having a negative electrode material mixture layer was formed. The negative electrode plate was punched into a piece in a size of 34 mm×44 mm, which was used as the negative electrode.

### Fabrication of Lithium-Ion Secondary Battery

A container was prepared by forming an aluminum laminate for secondary battery (available from Dai Nippon Printing Co., Ltd.) into a bag by heat sealing. The positive and negative electrodes prepared through the above-described processes and a separator sandwiched therebetween were formed into a layered structure, and placed in the. container. An electrolytic solution was poured onto interfaces of the electrodes, and then, the container decompressed to −9.5 kPa to be sealed. A lithium-ion secondary battery was fabricated in this manner. As the separator, a microporous polyethylene membrane having one surface coated with alumina particles of about 5 μm was used. The electrolytic solution included a mixed solvent containing ethylene carbonate, ethyl methyl carbonate, and dimethyl carbonate at a volumetric ratio of 30:30:40, and LiPF₆ as an electrolytic salt dissolved in the mixed solvent at a concentration of 1.2 mol/L.

### Examples 2 to 13 and Comparative Examples 1 to 4

Lithium-ion secondary batteries of Examples 2 to 13 and Comparative Examples 1 to 4 were fabricated in the same manner as in Example 1, except that the negative electrodes included graphite particles A, graphite particles B, high dielectric inorganic solids, binding agents, and electron conductive materials of the respective types in the respective proportions shown in Tables 3 and 4. For Comparative Examples 1 to 3, no high dielectric inorganic solid was added. For Comparative Example 4, the graphite particles A1 were used alone as the graphite particles.

### Evaluation

The lithium-ion secondary batteries including the negative electrodes of Examples 1 to 13 and Comparative Examples 1 to 4 were evaluated in the following manner.

### Initial Performance (Discharge Capacity)

Each of the fabricated lithium-ion secondary batteries was left at a measurement temperature (25° C.) for one hour, and constant-current charge was carried out at 8.4 mA until 4.2 V was reached. Subsequently, constant-voltage charge was carried out at a voltage of 4.2 V for one hour, and thereafter, the secondary battery was left for 30 minutes. Constant-current discharge was then carried out at a current value of 8.4 mA until 2.5 V was reached. This series of operations was repeated five times, and the discharge capacity at the fifth discharge was determined as the initial discharge capacity (mAh). The results are shown in Tables 3 and 4. For each determined discharge capacity, a current value at which discharge could be completed in one hour was defined as 1 C.

### Initial Performance (Initial Cell Resistance Value)

Each lithium-ion battery subjected to the initial discharge capacity measurement was left at a measurement temperature (25° C.) for one hour, and then, was charged at 0.2 C to be adjusted to a charge level (state of charge (SOC) of 50%. The adjusted secondary battery was left for 10 minutes. Next, the C rate was set to 0.5 C, and pulse discharge was carried out for 10 seconds, so that voltages during the 10-second discharge were measured. The voltages during the 10-second discharge with respect to the current at 0.5 C were plotted with reference to a horizontal axis representing the current value and a vertical axis representing the voltage. Next, after the secondary battery was left for 10 minutes, auxiliary charge was carried out to restore the SOC to 50%, and thereafter, the secondary battery was left for another 10 minutes. This series of operations was performed for each of C rates of 1.0 C, 1.5 C, 2.0 C, 2.5 C, and 3.0 C, and voltages during the 10-second discharge at the current value corresponding to each C rate were plotted. From each of the plots, an approximate line was calculated by the least-squares method. A gradient of the calculated approximate line was defined as the initial cell resistance value (Ω) of each lithium-ion secondary battery of the Examples and the Comparative Examples. The results are shown in Tables 3 and 4.

### Post-Durability-Test Performance (Discharge Capacity)

A charge-discharge cycle durability test was performed in the following manner. In a thermostatic chamber at 45° C., each secondary battery was subjected to a constant-current charge at a charge rate of 1 C until 4.2 V was reached, and then, to constant-current discharge at a discharge rate of 2 C until 2.5 V was reached. This series of operations was defined as one cycle, and each secondary battery was subjected to 500 cycles. After completion of the 500 cycles, the temperature of the thermostatic chamber was reset to 25° C., and the secondary battery was left therein for 24 hours. Thereafter, constant-current charge was carried out at 0.2 C until 4.2 V was reached, and subsequently, constant-voltage charge at a voltage of 4.2 V was carried out for one hour. The secondary battery was then left for 30 minutes, and then, constant-current discharge was carried out at a discharge rate of 0.2 C until 2.5 V was reached. A post-durability-test discharge capacity (mAh) was then measured. The results are shown in Tables 3 and 4.

### Post-Durability-Test Cell Resistance Value

Each lithium-ion secondary battery subjected to the discharge capacity measurement subsequent to the durability test was charged until its state of charge (SOC) reaches 50%, in the same way as in the initial cell resistance value measurement. A post-durability-test ceil resistance value (Ω) was determined in the same manner as in the initial ceil resistance value measurement. The results are shown in Tables 3 and 4.

### Post-Durability-Test Capacity Maintenance Rate

A ratio of a post-durability-test discharge capacity (mAh) to the initial discharge capacity (mAh) was calculated and determined as a post-durability-test capacity maintenance rate (%). The results are shown in Tables 3 and 4.

### Post-Durability-Test Resistance Increase Rate

The ratio of the post-durability-test cell resistance value to the initial cell resistance value (Ω) was calculated and determined as a cell resistance increase rate (%). The results are shown in Tables 3 and 4.

TABLE 3

| | | Example | Example | Example | Example | Example | Example | Example |
|---|---|---|---|---|---|---|---|---|
| | | 1 | 2 | 3 | 4 | 5 | 6 | 7 |
| Graphite | Type of Graphite | A1 | A1 | A1 | A1 | A1 | A1 | A1 |
| Particles | Particles A | | | | | | | |
| | Type of Graphite | B1 | B1 | B1 | B1 | B1 | B1 | B1 |
| | Particles B | | | | | | | |
| | A:B (Weight Ratio) | 95:5 | 55:45 | 70:30 | 70:30 | 70:30 | 70:30 | 70:30 |
| Type of High Dielectric | | NSS | NSS | NSS | NSS | NSS | SBT | LPO |
| Inorganic Solid (Abbreviation) | | | | | | | | |
| Composition | Positive Electrode | 94.0 | 94.0 | 94.0 | 94.0 | 94.0 | 94.0 | 94.0 |
| of Positive | Active Material | | | | | | | |
| Electrode | Acetylene Black | 4.2 | 4.2 | 4.2 | 4.2 | 4.2 | 4.2 | 4.2 |
| (wt %) | PVdP | 1.8 | 1.8 | 1.8 | 1.8 | 1.8 | 1.8 | 1.8 |
| Composition | Type of Graphite | 91.0 | 52.5 | 66.9 | 66.9 | 66.0 | 66.9 | 66.9 |
| of Negative | Particles A | | | | | | | |
| Electrode | Type of Graphite | 5.0 | 43.5 | 29.1 | 29.5 | 29.5 | 29.1 | 29.1 |
| (wt %) | Particles B | | | | | | | |
| | High Dielectric | 0.5 | 0.5 | 0.5 | 0.1 | 1.0 | 0.5 | 0.5 |
| | Inorganic Solid | | | | | | | |
| | Acetylene Black | 1.0 | 1.0 | 1.0 | 1.0 | 1.0 | 1.0 | 1.0 |
| | CMC | 1.0 | 1.0 | 1.0 | 1.0 | 1.0 | 1.0 | 1.0 |
| | SBR | 1.5 | 1.5 | 1.5 | 1.5 | 1.5 | 1.5 | 1.5 |
| Initial | Discharge Capacity | 42.6 | 42.1 | 43.2 | 42.7 | 42.5 | 42.5 | 42.6 |
| Performance | (mAh) | | | | | | | |
| | Initial Cell | 917.4 | 908.3 | 903.9 | 922.0 | 926.7 | 912.9 | 915.6 |
| | Resistance Value (Ω) | | | | | | | |
| Post- | Discharge Capacity | 38.0 | 37.9 | 38.0 | 38.4 | 38.8 | 37.4 | 37.6 |
| Durability- | (mAh) | | | | | | | |
| Test | Post-Durability-Test | 1200.0 | 1188.1 | 1176.5 | 1176.5 | 1182.3 | 1276.6 | 1224.5 |
| Performance | Cell Resistance | | | | | | | |
| | Value (Ω) | | | | | | | |
| Post-Durability-Test Capacity | | 89.2 | 90.0 | 88.0 | 89.9 | 91.2 | 88.1 | 88.3 |
| Maintenance Rate (%) | | | | | | | | |
| Post-Durability-Test | | 131 | 131 | 130 | 128 | 128 | 140 | 134 |
| Resistance Increase Rate (%) | | | | | | | | |
| | | | Example | Example | Example | Example | Example | Example |
| | | | 8 | 9 | 10 | 11 | 12 | 13 |

| Graphite | Type of Graphite | A1 | A2 | A3 | A1 | A1 | A1 |
|---|---|---|---|---|---|---|---|
| Particles | Particles A | | | | | | |
| | Type of Graphite | B1 | B1 | B1 | B2 | B3 | B4 |
| | Particles B | | | | | | |
| | A:B (Weight Ratio) | 70:30 | 70:30 | 70:30 | 70:30 | 70:30 | 70:30 |
| Type of High Dielectric | | LNO | NSS | NSS | NSS | NSS | NSS |
| Inorganic Solid (Abbreviation) | | | | | | | |
| Composition | Positive Electrode | 94.0 | 94.0 | 94.0 | 94.0 | 94.0 | 94.0 |
| of Positive | Active Material | | | | | | |
| Electrode | Acetylene Black | 4.2 | 4.2 | 4.2 | 4.2 | 4.2 | 4.2 |
| (wt %) | PVdP | 1.8 | 1.8 | 1.8 | 1.8 | 1.8 | 1.8 |
| Composition | Type of Graphite | 66.9 | 66.9 | 66.9 | 66.9 | 66.9 | 66.9 |
| of Negative | Particles A | | | | | | |
| Electrode | Type of Graphite | 29.1 | 29.1 | 29.1 | 29.1 | 29.1 | 29.1 |
| (wt %) | Particles B | | | | | | |
| | High Dielectric | 0.5 | 0.5 | 0.5 | 0.5 | 0.5 | 0.5 |
| | Inorganic Solid | | | | | | |
| | Acetylene Black | 1.0 | 1.0 | 1.0 | 1.0 | 1.0 | 1.0 |
| | CMC | 1.0 | 1.0 | 1.0 | 1.0 | 1.0 | 1.0 |
| | SBR | 1.5 | 1.5 | 1.5 | 1.5 | 1.5 | 1.5 |
| Initial | Discharge Capacity | 43.0 | 42.4 | 42.5 | 42.6 | 42.5 | 42.1 |
| Performance | (mAh) | | | | | | |
| | Initial Cell | 899.4 | 895.0 | 890.7 | 899.4 | 882.1 | 895.0 |
| | Resistance Value (Ω) | | | | | | |
| Post- | Discharge Capacity | 38.4 | 38.6 | 38.0 | 38.4 | 38.0 | 38.1 |
| Durability- | (mAh) | | | | | | |
| Test | Post-Durability-Test | 1142.9 | 1126.8 | 1157.9 | 1124.3 | 1111.4 | 1136.7 |
| Performance | Cell Resistance | | | | | | |
| | Value (Ω) | | | | | | |

| | | | | | | |
|---|---|---|---|---|---|---|
| Post-Durability-Test Capacity | 89.3 | 91.0 | 89.4 | 90.1 | 89.4 | 89.3 |
| Maintenance Rate (%) | | | | | | |
| Post-Durability-Test | 127 | 126 | 130 | 125 | 126 | 127 |
| Resistance Increase Rate (%) | | | | | | |

TABLE 4

| | | Comparative | Comparative | Comparative | Comparative |
|---|---|---|---|---|---|
| | | Example1 | Example2 | Example3 | Example4 |
| Graphite | Type of Graphite | A1 | A2 | A3 | A4 |
| Particles | Particles A | | | | |
| | Type of Graphite | B1 | B2 | B3 | B4 |
| | Particles B | | | | |
| | A:B (Weight Ratio) | 95:5 | 95:45 | 70:30 | 100:0 |
| Type of High Dielectric Inorganic | | — | — | — | LNO |
| Solid (Abbreviation) | | | | | |
| Composition | Positive Electrode | 94.0 | 94.0 | 94.0 | 94.0 |
| of Positive | Active Material | | | | |
| Electrode | Acetylene Black | 4.2 | 4.2 | 4.2 | 4.2 |
| (wt %) | PVdF | 1.8 | 1.8 | 1.8 | 1.8 |
| Composition | Type of Graphite | 91.7 | 53.1 | 67.5 | 95.6 |
| of Negative | Particles A | | | | |
| Electrode | Type of Graphite | 4.8 | 43.4 | 29.0 | — |
| (wt %) | Particles B | | | | |
| | High Dielectric | — | — | — | 1.0 |
| | Inorganic Solid | | | | |
| | Acetylene Black | 1.0 | 1.0 | 1.0 | 1.0 |
| | CMC | 1.0 | 1.0 | 1.0 | 1.0 |
| | SBR | 1.5 | 1.5 | 1.5 | 1.5 |
| Initial | Discharge Capacity | 42.6 | 42.1 | 43.2 | 41.9 |
| Performance | (mAh) | | | | |
| | Initial Cell | 915.0 | 917.4 | 912.9 | 950.0 |
| | Resistance Value (Ω) | | | | |
| Post- | Discharge Capacity | 37.2 | 36.9 | 36.5 | 36.8 |
| Durability- | (mAh) | | | | |
| Test | Post-Durability-Test | 1360.0 | 1380.0 | 1440.0 | 1358.5 |
| Performance | Cell Resistance | | | | |
| | Value (Ω) | | | | |

| | | | | |
|---|---|---|---|---|
| Post-Durability-Test Capacity | 87.4 | 87.6 | 84.4 | 87.8 |
| Maintenance Rate (%) | | | | |
| Post-Durability-Test Resistance | 149 | 150 | 158 | 143 |
| Increase Rate (%) | | | | |

From the results shown in Tables 3 and 4, it has been confirmed that the lithium-ion secondary battery of each of the Examples has a higher post-durability-test capacity maintenance rate and a lower post-durability-test resistance increase rate than the lithium-ion secondary batteries of the Comparative Examples. In other words, it has been confirmed that the lithium-ion secondary battery of each of the Examples has excellent durability against charge-discharge cycles.

### Explanation of Reference Numerals

1: Lithium-Ion Secondary Battery

6: Negative Electrode Material Mixture Layer

7: Negative Electrode

11: Negative Electrode Active Material (Graphite Particles A)

12: Negative Electrode Active Material (Graphite Particles B)

13: High Dielectric Inorganic Solid

What is claimed is:

1. A negative electrode for a lithium-ion secondary battery, the negative electrode comprising:
an electrode material mixture layer including graphite particles as a negative electrode active material, and a high dielectric inorganic solid,
wherein the graphite particles include graphite particles A having an average particle diameter and graphite particles B having a different average particle diameter, and
wherein the graphite particles each include, on a surface thereof, a portion in contact with the high dielectric inorganic solid and a portion in contact with an electrolytic solution.

2. The negative electrode according to claim 1,
wherein the high dielectric inorganic solid is disposed in gaps between the graphite particles or on the surfaces of the graphite particles.

3. The negative electrode according to claim 1,
wherein the graphite particles A are integrated with the high dielectric inorganic solid and have a BET specific surface area of 1 m²/g to 3 m²/g, and the average particle diameter of the graphite particles A is 15 μm to 30 μm, and
wherein the graphite particles B have a BET specific surface area of 3 m²/g to 8 m²/g, and the average particle diameter of the graphite particles B is 5 μm to 15 μm.

4. The negative electrode according to claim 1,
wherein the high dielectric inorganic solid includes at least one of Li, Na, or Mg.

5. The negative electrode according to claim 1,
wherein the high dielectric inorganic solid has a reductive decomposition potential of 1.5 V (vs. Li/Li⁺) or less with respect to a Li/Li³⁰ equilibrium potential.

6. The negative electrode according to claim 1,
wherein the high dielectric inorganic solid has a relative permittivity of 10 or higher.

7. The negative electrode according to claim 1,
wherein the graphite particles A are contained at 55 wt. % to 95% wt. % with respect to a total weight of the graphite particles A and the graphite particles B.

8. The negative electrode according to claim 1,
wherein the high dielectric inorganic solid includes at. least one of compounds represented by Na₃₊ₓ(Sb₁₋ₓ,Snₓ)S₄ (0≤X≤0.1).

9. The negative electrode according to claim 1,
wherein the high dielectric inorganic solid is contained at 0.1 wt. % to 1.0 wt. % in the electrode material mixture layer.
